(19) United States
(12) Patent Application Publication
(10) Pub. No.: US 2025/0365065 A1
(43) Pub. Date: Nov. 27, 2025

(54) WIRELESS COMMUNICATION SYSTEM AND WIRELESS COMMUNICATION METHOD

(71) Applicant: Luxshare Precision Industry Company Limited, Shenzhen (CN)

(72) Inventors: Guan Hsiung WANG, Shenzhen (CN); Wei Hsin CHEN, Shenzhen (CN)

(21) Appl. No.: 19/173,306

(22) Filed: Apr. 8, 2025

(30) Foreign Application Priority Data
May 21, 2024 (CN) 2024106353941

(51) Int. Cl. H04B 7/185; H04W 64/00; H04W 84/06

(52) U.S. Cl. CPC H04B 7/18506; H04W 64/003; H04W 84/06

(57) ABSTRACT

A wireless communication system and a wireless communication method are provided, and the wireless communication system includes a mother UAV and a plurality of child UAVs. The plurality of child UAVs are wirelessly connected to each other. The mother UAV is wirelessly connected to the plurality of child UAVs and forms a UAV network with the plurality of child UAVs. The mother UAV or one of the plurality of child UAVs receives a packet, and the mother UAV obtains a target base station from the packet or the child UAV which receives the packet. The mother UAV determines whether the target base station lies within the signal coverage range of the UAV network. When the mother UAV determines that the target base station lies within the signal coverage range of the UAV network, the packet is transmitted to the target base station by the UAV network.

### CROSS-REFERENCE TO RELATED APPLICATIONS

This application claims the priority benefit of Chinese Patent Application Serial Number 2024106353941, filed on May 21, 2024, the full disclosure of which is incorporated herein by reference.

### TECHNICAL FIELD OF THE INVENTION

The present disclosure is related to a technical field of communication and is particularly related to a wireless communication system and a wireless communication method.

### DESCRIPTION OF THE PRIOR ART

An unmanned aerial vehicle (UAV) is a radio-controlled aircraft without any pilot on board. The UAV is manipulated by radio-controlled technologies, autopilot or self-driving so that the UAV has numerous advantages such as high maneuverability, small size and low cost and is widely used in many application fields such as scientific research, site investigation, disaster assistance, farm monitoring and militaries.

When the UAV is applied to the disaster assistance but the base stations or the relay stations adjacent to a disaster region are collapsed or malfunction, the packets with disaster data which the UAV is eager to transmit can not be immediately transmitted to disaster relief workers by the base stations or the relay stations, and it results in the occurrence of delays in disaster relief. Hence, how to utilize the UAV to serve as a network node or the relay station is an important issue.

### SUMMARY

In light of the aforementioned descriptions, the present disclosure provides a wireless communication system and a wireless communication method to solve the problem that the packets can not be immediately transmitted due to the collapse or the malfunctioning of the base stations or the relay stations adjacent to the disaster region.

Based on the aforementioned descriptions, the present disclosure is to provide the wireless communication system. The wireless communication system includes a plurality of child UAVs and a mother UAV. The plurality of child UAVs are wirelessly connected to each other. The mother UAV is wirelessly connected to the plurality of child UAVs and forms a UAV network with the plurality of child UAVs. The mother UAV or one of the plurality of child UAVs receives a packet, and the mother UAV obtains a target base station from the packet or the child UAV which receives the packet. The mother UAV determines whether the target base station lies within the signal coverage range of the UAV network. When the mother UAV determines that the target base station lies within the signal coverage range of the UAV network, the packet is transmitted to the target base station by the UAV network.

In the embodiments of the present disclosure, transmitting the packet to the target base station by the UAV network includes: the mother UAV and at least one of the plurality of child UAVs cooperatively transmit the packet to the target base station.

In the embodiments of the present disclosure, the child UAV which receives the packet is a first child UAV, and the child UAV which does not receive the packet is a second child UAV. Transmitting the packet to the target base station by the UAV network includes: the first child UAV and at least one of the second child UAVs cooperatively transmit the packet to the target base station.

In the embodiments of the present disclosure, the mother UAV or the first child UAV determines whether the packet is a client packet. When the mother UAV or the first child UAV determines that the packet is the client packet, the mother UAV or the first child UAV receives the packet. When the mother UAV or the first child UAV determines that the packet is not the client packet, the mother UAV, the first child UAV or at least one of the second child UAVs receives another packet.

In the embodiments of the present disclosure, the mother UAV or the first child UAV determines whether the packet includes a 5G message. When the mother UAV or the first child UAV determines that the packet includes the 5G message, the mother UAV or the first child UAV receives the packet. When the mother UAV or the first child UAV determines that the packet does not include the 5G message, the mother UAV, the first child UAV or at least one of the second child UAVs receives another packet.

In the embodiments of the present disclosure, when the mother UAV determines that the target base station does not lie within the signal coverage range of the UAV network, the packet is transmitted to the target base station by an external network.

In the embodiments of the present disclosure, the mother UAV and each of the plurality of child UAVs serve as relay stations.

Based on the aforementioned descriptions, the present disclosure is to provide the wireless communication method performed by the wireless communication system including the UAV network. The wireless communication method includes: receiving a packet and obtaining a target base station according to the packet; determining whether the target base station lies within the signal coverage range of the UAV network; when determining that the target base station lies within the signal coverage range of the UAV network, transmitting the packet to the target base station by the UAV network.

In the embodiments of the present disclosure, when determining that the target base station does not lie within the signal coverage range of the UAV network, transmitting the packet to the target base station by an external network.

In the embodiments of the present disclosure, the wireless communication method further includes: determining whether the packet is a client packet; when determining that the packet is the client packet, receiving the packet; when determining that the packet is not the client packet, receiving another packet.

In the embodiments of the present disclosure, the wireless communication method further includes: determining whether the packet includes a 5G message; when determining that the packet includes the 5G message, receiving the packet; when determining that the packet does not include the 5G message, receiving another packet.

In view of the above descriptions, the wireless communication system and the wireless communication method select the UAV network constituted by the mother UAV and the plurality of child UAVs or the external network to transmit the packet to the target base station by determining whether the target base station of the packet lies within the signal coverage range of the UAV network. When the UAV network is selected to transmit the packet to the target base station, each of the plurality of child UAVs and the mother UAV may serve as relay stations to assist in transmitting the packet so that the packet is successfully transmitted to the target base station.

In addition, when the wireless communication system and the wireless communication method are applied to the investigation of natural environments or empty regions with few people, the UAV network may cooperate with the base stations residing in the natural environments or the empty regions so that the signal coverage range of Internet of Things (IoT) may be expanded, thus reducing the needed signal transmission distance to transmit the packet to the target base station. Afterwards, the shorter signal transmission distance significantly decreases the transmission power between the adjacent nodes of the IoT to reduce the power consumption between the adjacent nodes of the IoT.

The aforementioned description of the present disclosure is merely the outline of the technical solutions of the present disclosure. In order to understand the technical solutions of the present disclosure clearly and to implement the present disclosure according to the content of the specification, the better embodiments of the present disclosure given herein below with accompanying drawings are used to describe the present disclosure in detail.

### BRIEF DESCRIPTION OF DRAWINGS

FIG. 1 depicts a configuration diagram of a wireless communication system according to one embodiment of the present disclosure.

FIG. 2 depicts a flowchart of a wireless communication method according to one embodiment of the present disclosure.

FIG. 3A and FIG. 3B depict a flowchart of a wireless communication method according to another embodiment of the present disclosure.

### DETAILED DESCRIPTION

The specific embodiments of the present disclosure given herein below is used to explain the implementation of the present disclosure. A person skilled in the art easily understands the advantages and the effects of the present disclosure from the content of the present disclosure.

It should be noted that the embodiments and the features in the embodiments of the present disclosure can be combined with each other without conflict. The present disclosure will be described in detail below with reference to accompanying drawings and in conjunction with the embodiments. In order to provide those in the art with better understanding of the solution of the disclosure, the technical solutions in the embodiments of the present disclosure will be described clearly and completely below in conjunction with the accompanying drawings in the embodiments of the present disclosure. Apparently, the described embodiments are merely one part of the embodiments of the present disclosure and not all embodiments of the present disclosure. Based on the embodiments of the present disclosure, all embodiments obtained by a person skilled in the art without any inventive steps shall fall within the scope of protection of the present disclosure.

It should be noted that the terms “first”, “second”, etc. in the specification and claims of the present disclosure and in the aforementioned accompanying drawings are used to distinguish similar objects and not used to describe a particular order or sequence. Furthermore, the terms “comprising” and “having”, and any variation thereof, are intended to encompass a non-exclusive inclusion, for example, a series of steps or units comprising processes, methods, systems, products or equipment do not need to be limited to those steps or units clearly listed but may include other steps or units not clearly listed or inherent to those processes, methods, products or equipment.

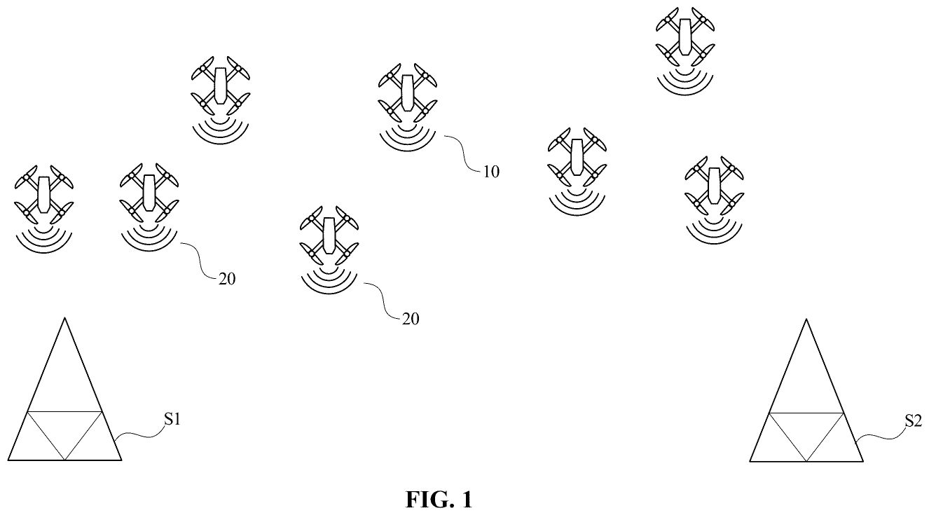

Please refer to FIG. 1, which depicts a configuration diagram of a wireless communication system according to one embodiment of the present disclosure. As shown in FIG. 1, a wireless communication system includes a mother UAV 10 and a plurality of child UAVs 20. The plurality of child UAVs 20 are wirelessly connected to each other. The mother UAV 10 is wirelessly connected to the plurality of child UAVs 20 and forms a UAV network with the plurality of child UAVs 20. Specifically, the mother UAV 10 transmits a communication message or a handshake message to each of the plurality of child UAVs 20, each of the plurality of child UAVs 20 transmits a response signal to the mother UAV 10 according to the communication message or the handshake message, and the mother UAV 10 ensures the position and the signal coverage range of each of the plurality of child UAVs 20 according to the response signal of each of the plurality of child UAVs 20. After ensuring the position and the signal coverage range of each of the plurality of child UAVs 20, the mother UAV 10 and the plurality of child UAVs 20 cooperatively form the UAV network; in other words, the UAV network serves as a wireless relay network, and the mother UAV 10 and each of the plurality of child UAVs 20 are disposed on the plurality of network nodes of the UAV network and serve as relay stations. The UAV network belongs to 5G IoT and can be connected to 5G base stations, and the signal coverage range of the UAV network is wider than the signal coverage range of the mother UAV 10.

In addition, the number of the mother UAVs 10 is multiple, and the multiple mother UAVs 10 and the plurality of child UAVs 20 constitutes a plurality of UAV networks. For example, the number of the mother UAVs 10 is three, the number of the plurality of child UAVs 20 is twelve, one mother UAV 10 and three child UAVs 20 constitute one UAV network, and three mother UAVs and twelve child UAVs 20 constitute three UAV networks. The aforementioned descriptions are exemplarily enumerated, and the number of the mother UAVs 10 and the number of the plurality of child UAVs 20 may be adjusted according to use requirements but not be limited thereto.

It should be noted that the mother UAV 10 and each of the plurality of child UAVs 20 have functions of capturing images, positioning, wireless communication, sensing sound and sensing temperature, i.e., the functions which the mother UAV 10 and each of the plurality of child UAVs 20 are provided are the same as the functions which the current UAV is provided. The functions which the mother UAV 10 and each of the plurality of child UAVs 20 have may add other functions (e.g., sensing humidity) according to actual application requirements but not be limited thereto.

The mother UAV 10 or one of the plurality of child UAVs 20 receives a packet, and the mother UAV 10 obtains a target base station B2 from the packet or the child UAV which receives the packet. The child UAV 20 which receives the packet is a first child UAV, the child UAV 20 which does not receive the packet is a second child UAV, and the first child UAV and the second child UAV are types for distinguishing. In one embodiment, the mother UAV 10 or the first child UAV receives the packet from a source base station B1, and the mother UAV 10 obtains the target base station B2 from the packet, or the first child UAV obtains the target base station B2 from the packet and transmits the target base station B2 to the mother UAV 10. In another embodiment, the target base station B2 is previously set on the processor of the mother UAV 10 and the processor of each of the plurality of child UAVs 20, and the mother UAV 10 or one of the plurality of child UAVs 20 performs the image capture and the sound detection on the surrounding environments thereof to generate video data and generates the packet according to the video data. It should be noted that the source base station B1 is the transmission starting point belonging to a transmitter side to transmit the packet to the mother UAV 10 or the first child UAV; the target base station B2 is the transmission ending point belonging to a receiver side to receive the packet from the UAV network or an external network. The external network is other network except the UAV network and may include a plurality of base stations and a plurality of relay stations.

Taking one example, when the wireless communication system is applied to mountain rescue, the source base station B1 is the base station located on a high mountain, disaster victims transmit rescue messages to the source base station B1, and the base station B1 generates and transmits the packet to the mother UAV 10 or the first child UAV according to the rescue messages. The mother UAV 10 or the first child UAV learns that the target base station B2 is the base station where disaster relief workers are located according to the packet, and the packet is transmitted to the target base station B2 by the UAV network or the external network. Taking another example, when the wireless communication system is applied to the mountain rescue, the target base station B2 is previously set on the processor of the mother UAV 10 and the processor of each of the plurality of child UAVs 20, and the target base station B2 is the base station where the disaster relief workers are located. The mother UAV 10 or one of the plurality of child UAVs 20 performs the image capture and the sound detection on the environment where the disaster victims are located to generate the video data and generates the packet according to the video data. Afterwards, the packet is transmitted to the target base station B2 by the UAV network or the external network.

The mother UAV 10 generates a determination result according to the signal coverage range of the target base station B2 and the signal coverage range of the UAV network, and selects the UAV network or the external network to transmit the packet to the target base station B2 according to the determination result. The operation details of selecting the UAV network or the external network to transmit the packet to the target base station B2 according to the determination result will be described in the paragraphs of a wireless communication method.

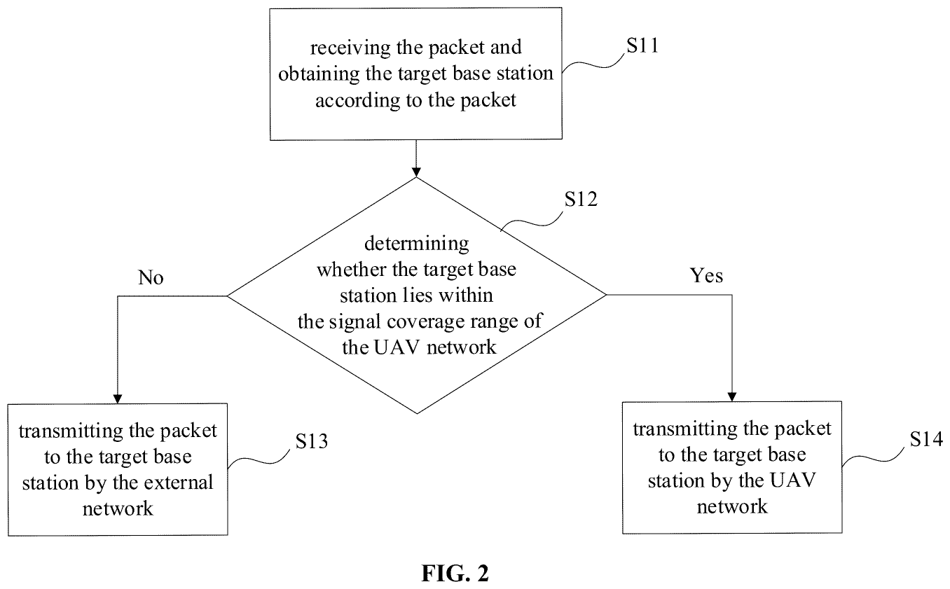

Please refer to FIG. 2, which depicts a flowchart of a wireless communication method according to one embodiment of the present disclosure. As shown in FIG. 2, the wireless communication method includes step S11˜step S14. The wireless communication method shown in FIG. 2 may be applicable to the wireless communication system shown in FIG. 1 but is not limited thereto. For example, the step S11˜step S14 would be explained by the wireless communication system shown in FIG. 1 as follows.

Step S11: receiving the packet and obtaining the target base station B2 according to the packet. As described above, the mother UAV 10 or the first child UAV receives the packet, and the mother UAV 10 learns the target base station B2 from the packet or the first child UAV.

Step S12: determining whether the target base station B2 lies within the signal coverage range of the UAV network. Specifically, the mother UAV 10 determines whether the target base station B2 lies within the signal coverage range of the mother UAV 10 or the signal coverage range of one of the plurality of child UAVs 20. When determining that the target base station B2 lies within the signal coverage range of the mother UAV 10 or the signal coverage range of one of the plurality of child UAVs 20, the mother UAV 10 subsequently performs step S14. When determining that the target base station B2 does not lie within the signal coverage range of the mother UAV 10 or the signal coverage range of one of the plurality of child UAVs 20, the mother UAV 10 subsequently performs step S13.

Step S13: transmitting the packet to the target base station B2 by the external network. Specifically, the mother UAV 10 transmits an assistance request to one base station or one relay station of the external network, and the base station or the relay station which receives the assistance request transmits an agreement signal to the mother UAV 10. Thereafter, the mother UAV 10 transmits the packet to the base station or the relay station which transmits the agreement signal, and the plurality of base stations and the plurality of relay stations of the external network cooperatively transmit the packet to the target base station B2. Or the mother UAV 10 controls the first child UAV to transmit the packet to the base station or the relay station which transmits the agreement signal, and the plurality of base stations and the plurality of relay stations of the external network cooperatively transmit the packet to the target base station B2.

Step S14: transmitting the packet to the target base station B2 by the UAV network. In one embodiment, when the mother UAV 10 receives the packet and determines that the target base station B2 lies within the signal coverage range of one of the plurality of child UAVs 20, the child UAV 20 of which the signal coverage range encompasses the target base station B2 is a first target child UAV, the mother UAV 10 transmits the packet to the first target child UAV by the transferring of at least one child UAV 20, and the first target child UAV transmits the packet to the target base station B2. In other words, the mother UAV 10, the first target child UAV, and at least one child UAV 20 cooperatively transmit the packet to the target base station B2.

In another embodiment, when the first child UAV receives the packet and the mother UAV 10 determines that the target base station B2 lies within the signal coverage range of one of the plurality of second child UAVs, the second child UAV of which the signal coverage range encompasses the target base station B2 is a second target child UAV, the mother UAV 10 controls the first child UAV and at least one second child UAV to cooperatively transmit the packet to the second target child UAV, and the second target child UAV transmits the packet to the target base station B2. In other words, the first child UAV, at least one second child UAV and the second target child UAV cooperatively transmit the packet to the target base station B2.

In the wireless communication method of the present embodiment, by determining whether the target base station of the packet lies within the signal coverage range of the UAV network, the UAV network or the external network is selected to transmit the packet to the target base station. When the UAV network is selected to transmit the packet to the target base station, each of the plurality of child UAVs and the mother UAV may serve as relay stations to assist in transmitting the packet so that the packet can be successfully transmitted to the target base station. When the external network is selected to transmit the packet to the target base station, each of the plurality of child UAVs and the mother UAV may communicate with one base station or one relay station of the external network to transmit the packet to the external network, and the plurality of base stations and the plurality of relay stations of the external network cooperatively transmit the packet to the target base station.

When the wireless communication method of the present disclosure is applied to disaster rescue and the base station adjacent to a disaster region is collapsed or malfunction, the base station where disaster relief workers are located is previously set as the target base station, the mother UAV controls at least one child UAV to move to the surroundings of the disaster region. Afterwards, the child UAV which is located on the surroundings of the disaster region generates the packet, and the mother UAV controls the child UAV which generates the packet and the other child UAVs to cooperatively transmit the packet to the target base station, thus facilitating the disaster relief workers to control the conditions of the disaster.

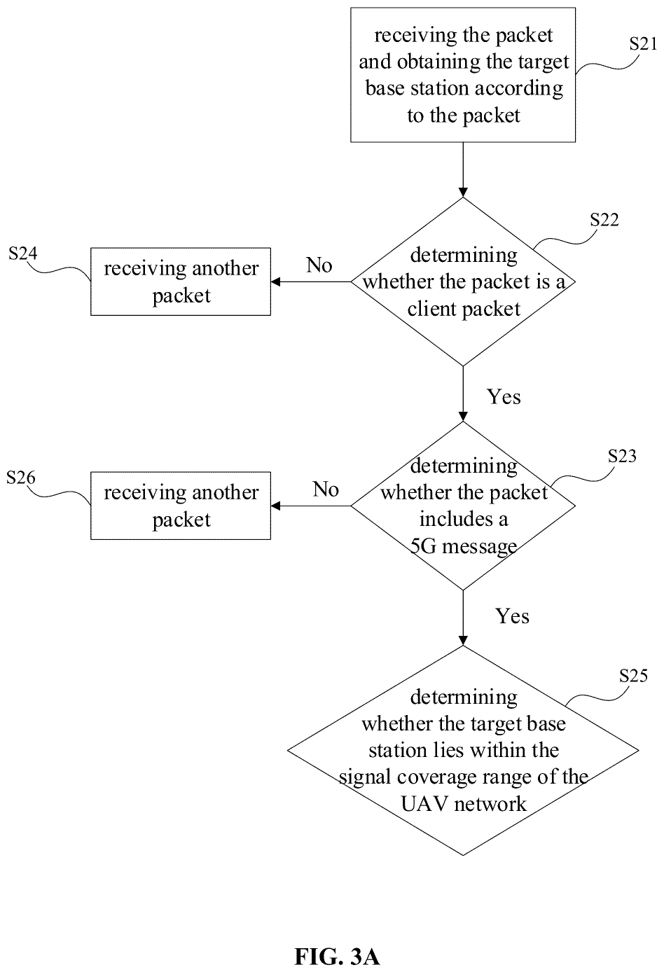

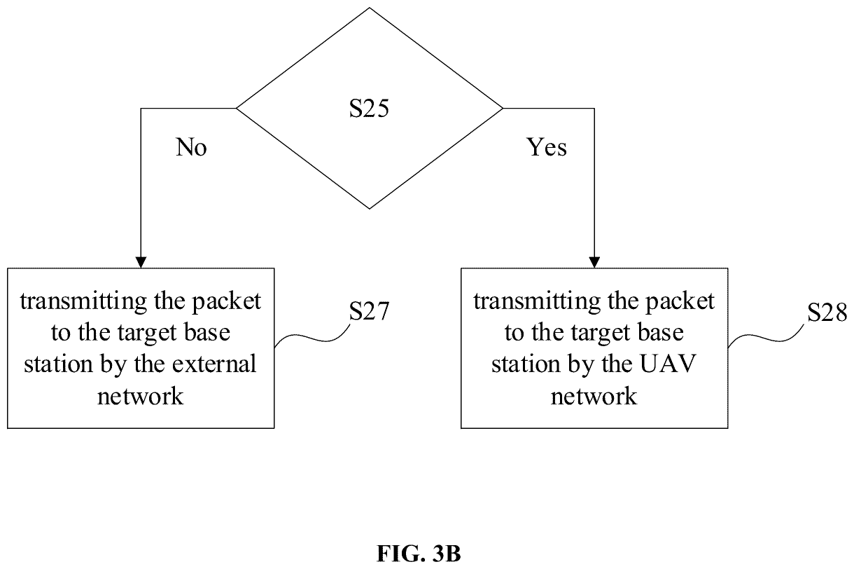

Please refer to FIG. 3A and FIG. 3B, which depict a flowchart of a wireless communication method according to another embodiment of the present disclosure. As shown in FIG. 3, the wireless communication method includes step S21˜step S28. Step S21, step S25, step S27 and step S28 are the same as step S11˜step S14 shown in FIG. 2 and would not be repeated again. Step S22 is to determine whether the packet of the source base station B1 is a client packet, and step S23 is determine whether the packet includes a 5G message.

Step S22: determining whether the packet is a client packet. Specifically, the mother UAV 10 or the first child UAV determines whether the packet has the label for the client packet. When determining that the packet has the label for the client packet, the mother UAV 10 or the first child UAV subsequently performs step S23. When determining that the packet does not have the label for the client packet, the mother UAV 10 or the first child UAV subsequently performs step S24.

Step S23: determining whether the packet includes a 5G message. When determining that the packet includes the 5G message, the mother UAV 10 or the first child UAV subsequently performs step S25. When determining that the packet does not include the 5G message, the mother UAV 10 or the first child UAV subsequently performs step S26.

Step S24: receiving another packet. Specifically, the mother UAV 10 or the first child UAV refuses the packet which is not the client packet, and the mother UAV 10 or one of the plurality of child UAVs 20 receives another packet.

Step S26: receiving another packet. Specifically, the mother UAV 10 or the first child UAV refuses the packet which does not include the 5G message, and the mother UAV 10 or one of the plurality of child UAVs 20 receives another packet.

In view of the above descriptions, the wireless communication system and the wireless communication method select the UAV network constituted by the mother UAV and the plurality of child UAVs or the external network to transmit the packet to the target base station by determining whether the target base station of the packet lies within the signal coverage range of the UAV network. When the UAV network is selected to transmit the packet to the target base station, each of the plurality of child UAVs and the mother UAV may serve as relay stations to assist in transmitting the packet so that the packet is successfully transmitted to the target base station.

In addition, when the wireless communication system and the wireless communication method are applied to the investigation of natural environments or empty regions with few people, the UAV network may cooperate with the base stations residing in the natural environments or the empty regions so that the signal coverage range of Internet of Things (IoT) may be expanded, thus reducing the needed signal transmission distance to transmit the packet to the target base station. Afterwards, the shorter signal transmission distance significantly decreases the transmission power between the adjacent nodes of the IoT to reduce the power consumption between the adjacent nodes of the IoT.

What is claimed is:

1. A wireless communication system comprising:
a plurality of child UAVs wirelessly connected to each other;
a mother UAV wirelessly connected to the plurality of child UAVs and forming a UAV network with the plurality of child UAVs, wherein the mother UAV or one of the plurality of child UAVs receives a packet, and the mother UAV obtains a target base station from the packet or the child UAV which receives the packet;
wherein, the mother UAV determines whether the target base station lies within a signal coverage range of the UAV network, and when the mother UAV determines that the target base station lies within the signal coverage range of the UAV network, the packet is transmitted to the target base station by the UAV network.

2. The wireless communication system according to claim 1, wherein transmitting the packet to the target base station by the UAV network comprises: the mother UAV and at least one of the plurality of child UAVs cooperatively transmit the packet to the target base station.

3. The wireless communication system according to claim 1, wherein the child UAV which receives the packet is a first child UAV, the child UAV which does not receive the packet is a second child UAV, and transmitting the packet to the target base station by the UAV network comprises: the first child UAV and at least one of the second child UAVs cooperatively transmit the packet to the target base station.

4. The wireless communication system according to claim 3, wherein the mother UAV or the first child UAV determines whether the packet is a client packet; when the mother UAV or the first child UAV determines that the packet is the client packet, the mother UAV or the first child UAV receives the packet; when the mother UAV or the first child UAV determines that the packet is not the client packet, the mother UAV, the first child UAV or at least one of the second child UAVs receives another packet.

5. The wireless communication system according to claim 3, wherein the mother UAV or the first child UAV determines whether the packet comprises a 5G message; when the mother UAV or the first child UAV determines that the packet comprises the 5G message, the mother UAV or the first child UAV receives the packet; when the mother UAV or the first child UAV determines that the packet does not comprise the 5G message, the mother UAV, the first child UAV or at least one of the second child UAVs receives another packet.

6. The wireless communication system according to claim 1, wherein when the mother UAV determines that the target base station does not lie within the signal coverage range of the UAV network, the packet is transmitted to the target base station by an external network.

7. The wireless communication system according to claim 1, wherein the mother UAV and each of the plurality of child UAVs serve as relay stations.

8. A wireless communication method performed by a wireless communication system which comprises a UAV network comprising:
receiving a packet and obtaining a target base station according to the packet;
determining whether the target base station lies within a signal coverage range of the UAV network; and
when determining that the target base station lies within the signal coverage range of the UAV network, transmitting the packet to the target base station by the UAV network.

9. The wireless communication method according to claim 8, wherein when determining that the target base station does not lie within the signal coverage range of the UAV network, transmitting the packet to the target base station by an external network.

10. The wireless communication method according to claim 8, further comprising:
determining whether the packet is a client packet;
when determining that the packet is the client packet, receiving the packet; and
when determining that the packet is not the client packet, receiving another packet.

11. The wireless communication method according to claim 8, further comprising:
determining whether the packet comprises a 5G message;
when determining that the packet comprises the 5G message, receiving the packet; and
when determining that the packet does not comprise the 5G message, receiving another packet.
